(19) United States
(12) Patent Application Publication
(10) Pub. No.: US 2025/0123519 A1
(43) Pub. Date: Apr. 17, 2025

(54) LIGHT ADJUSTMENT DEVICE

(71) Applicant: Japan Display Inc., Tokyo (JP)

(72) Inventors: Masato YOSHIDA, Tokyo (JP); Hirofumi OHIRA, Tokyo (JP)

(21) Appl. No.: 18/999,912

(22) Filed: Dec. 23, 2024

Related U.S. Application Data
(63) Continuation of application No. PCT/JP2023/017361, filed on May 9, 2023.

(30) Foreign Application Priority Data
Jul. 7, 2022 (JP) 2022-109595

(51) Int. Cl. G02F 1/1339; G02F 1/1347

(52) U.S. Cl. CPC G02F 1/1339; G02F 1/1347

(57) ABSTRACT

A light adjustment device includes a panel unit in which a plurality of light adjustment panels are stacked in a first direction, wherein each of the light adjustment panels includes a first substrate, a second substrate overlapping the first substrate, a liquid crystal layer positioned between the first and second substrates, a first seal material extending along the edge of the liquid crystal layer between the first and second substrates and provided with an injection opening, and a second seal material sealing the injection opening, the second seal material protruding outward from the edge of the light adjustment panel when viewed in a first direction, and when each of the light adjustment panels is sequentially designated as one light adjustment panel, the second seal material of the one light adjustment panel is positioned inside the edges of the other light adjustment panels other than the one light adjustment panel.

### CROSS-REFERENCE TO RELATED APPLICATION

This application claims the benefit of priority from Japanese Patent Application No. 2022-109595 filed on Jul. 7, 2022 and International Patent Application No. PCT/JP2023/017361 filed on May 9, 2023, the entire contents of which are incorporated herein by reference.

### BACKGROUND

### 1. Technical Field

The present disclosure relates to a light adjustment device.

### 2. Description of the Related Art

A light adjustment device includes, for example, a panel unit in which a plurality of light adjustment panels are stacked in the up-down direction (for example, refer to Japanese Patent Application Laid-open Publication No. 2004-333567). The light adjustment panel includes a first substrate, a second substrate, and a first seal material and a liquid crystal layer encapsulated between the first and second substrates. In a case where a liquid crystal injection opening is provided in the first seal material, a second seal material sealing the injection opening is provided.

In a case where the second seal material protrudes from a side part of the panel unit, the second seal material is potentially damaged during conveyance of the panel unit, for example.

### SUMMARY

According to an aspect of the present disclosure, a light adjustment device includes a panel unit in which a plurality of light adjustment panels are stacked in a first direction, wherein each of the light adjustment panels includes a first substrate, a second substrate overlapping the first substrate, a liquid crystal layer positioned between the first and second substrates, a first seal material extending along the edge of the liquid crystal layer between the first and second substrates and provided with an injection opening, and a second seal material sealing the injection opening, the second seal material protruding outward from the edge of the light adjustment panel when viewed in a first direction, and when each of the light adjustment panels is sequentially designated as one light adjustment panel, the second seal material of the one light adjustment panel is positioned inside the edges of the other light adjustment panels other than the one light adjustment panel when viewed in the first direction.

### BRIEF DESCRIPTION OF THE DRAWINGS

FIG. 1 is a schematic diagram of a light adjustment device according to a first embodiment when viewed from the upper side;

FIG. 2 is a schematic diagram illustrating a section of the light adjustment device according to the first embodiment;

FIG. 3 is a schematic diagram of a light adjustment panel according to the first embodiment when viewed from the upper side;

FIG. 4 is a schematic diagram of a first substrate included in the light adjustment panel of FIG. 3 when viewed from the upper side;

FIG. 5 is a schematic diagram of a second substrate included in the light adjustment panel of FIG. 3 when viewed from the upper side;

FIG. 6 is a schematic diagram illustrating a state in which the first substrate of FIG. 4 and the second substrate of FIG. 5 are placed over each other;

FIG. 7 is a schematic diagram illustrating the light adjustment panel positioned uppermost in a panel unit;

FIG. 8 is a schematic diagram illustrating the light adjustment panel positioned second uppermost in the panel unit;

FIG. 9 is a schematic diagram illustrating the light adjustment panel positioned third uppermost in the panel unit;

FIG. 10 is a schematic diagram illustrating the light adjustment panel positioned fourth uppermost in the panel unit;

FIG. 11 is a schematic diagram of a light adjustment device according to a second embodiment when viewed from the upper side;

FIG. 12 is a schematic diagram of a light adjustment panel according to the second embodiment when viewed from the upper side;

FIG. 13 is a schematic diagram illustrating part of FIG. 12 in an enlarged manner;

FIG. 14 is a schematic diagram of a first substrate included in the light adjustment panel of FIG. 12 when viewed from the upper side;

FIG. 15 is a schematic diagram of a second substrate included in the light adjustment panel of FIG. 12 when viewed from the upper side;

FIG. 16 is a schematic diagram illustrating the light adjustment panel positioned uppermost in the panel unit;

FIG. 17 is a schematic diagram illustrating the light adjustment panel positioned second uppermost in the panel unit;

FIG. 18 is a schematic diagram illustrating the light adjustment panel positioned third uppermost in the panel unit;

FIG. 19 is a schematic diagram illustrating the light adjustment panel positioned fourth uppermost in the panel unit;

FIG. 20 is a schematic diagram of a light adjustment panel according to a third embodiment when viewed from the upper side;

FIG. 21 is a schematic diagram of a first substrate included in the light adjustment panel of FIG. 20 when viewed from the upper side;

FIG. 22 is a schematic diagram of a second substrate included in the light adjustment panel of FIG. 20 when viewed from the upper side;

FIG. 23 is a schematic diagram of a light adjustment device according to a fourth embodiment when viewed from the upper side;

FIG. 24 is a schematic diagram of a light adjustment panel according to the fourth embodiment when viewed from the upper side;

FIG. 25 is a schematic diagram of a first substrate included in the light adjustment panel of FIG. 24 when viewed from the upper side;

FIG. 26 is a schematic diagram of a second substrate included in the light adjustment panel of FIG. 24 when viewed from the upper side;

FIG. 27 is a schematic diagram illustrating the light adjustment panel positioned uppermost in the panel unit;

FIG. 28 is a schematic diagram illustrating the light adjustment panel positioned second uppermost in the panel unit;

FIG. 29 is a schematic diagram illustrating the light adjustment panel positioned third uppermost in the panel unit; and

FIG. 30 is a schematic diagram illustrating the light adjustment panel positioned fourth uppermost in the panel unit.

### DETAILED DESCRIPTION

Aspects (embodiments) of the present disclosure will be described below in detail with reference to the accompanying drawings. Contents described below in the embodiments do not limit the present disclosure. Components described below include those that could be easily thought of by the skilled person in the art and those identical in effect. Components described below may be combined as appropriate.

What is disclosed herein is merely exemplary, and any modification that could be easily thought of by the skilled person in the art as appropriate without departing from the gist of the disclosure is contained in the scope of the present disclosure. For clearer description, the drawings are schematically illustrated for the width, thickness, shape, and the like of each component as compared to an actual aspect in some cases, but the drawings are merely exemplary and do not limit interpretation of the present disclosure. In the present specification and drawings, any element same as that already described with reference to an already described drawing is denoted by the same reference sign, and detailed description thereof is omitted as appropriate in some cases.

In an XYZ coordinate system illustrated in the drawings, an X direction is the right-left direction, and an X1 side is opposite an X2 side. The X1 side is also referred to as a left side, and the X2 side is also referred to as a right side. A Y direction is the front-back direction, and a Y1 side is opposite a Y2 side. The Y1 side is also referred to as a front side, and the Y2 side is also referred to as a back side. A Z direction is the up-down direction (stacking direction). A Z1 side is opposite a Z2 side. The Z1 side is also referred to as an upper side, and the Z2 side is also referred to as a lower side. The Z direction is also referred to as a first direction. The Z2 side is also referred to as one side in the first direction, and the Z1 side is also referred to as the other side in the first direction.

### First Embodiment

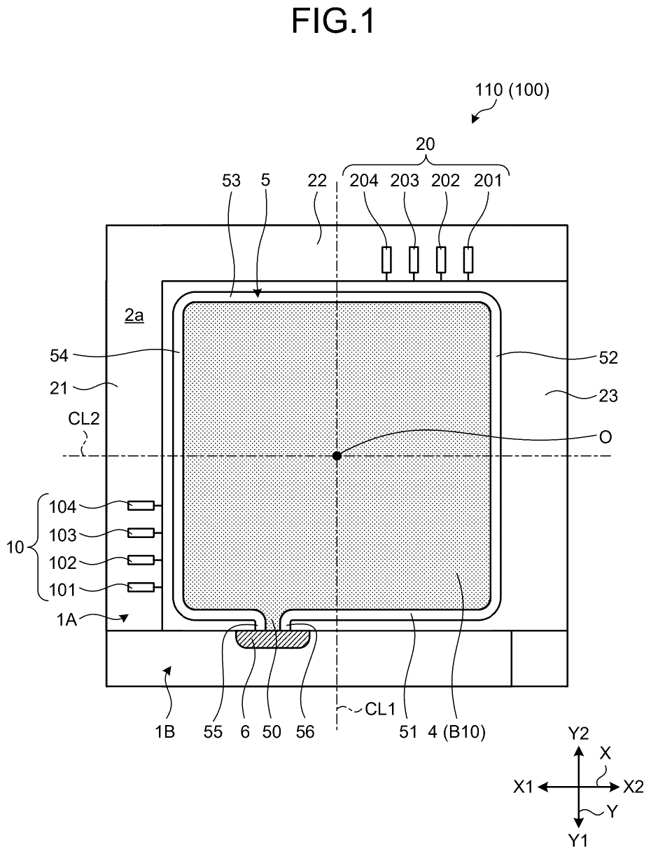

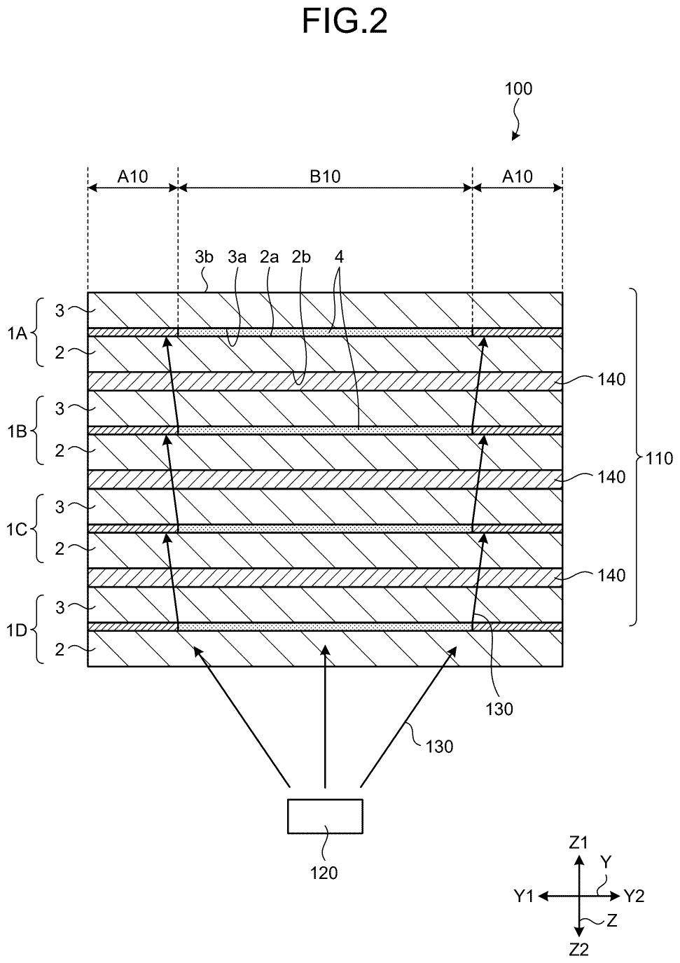

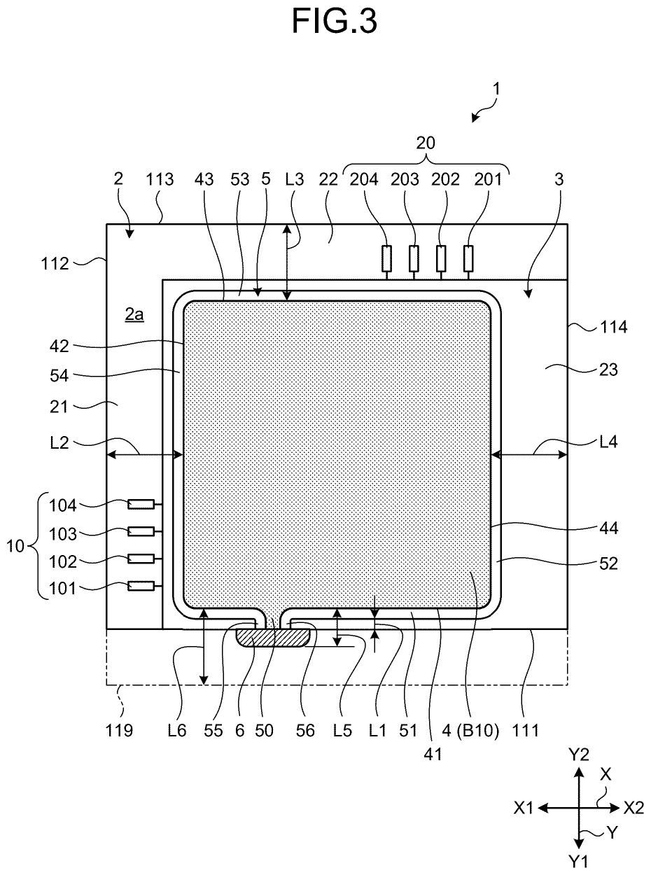

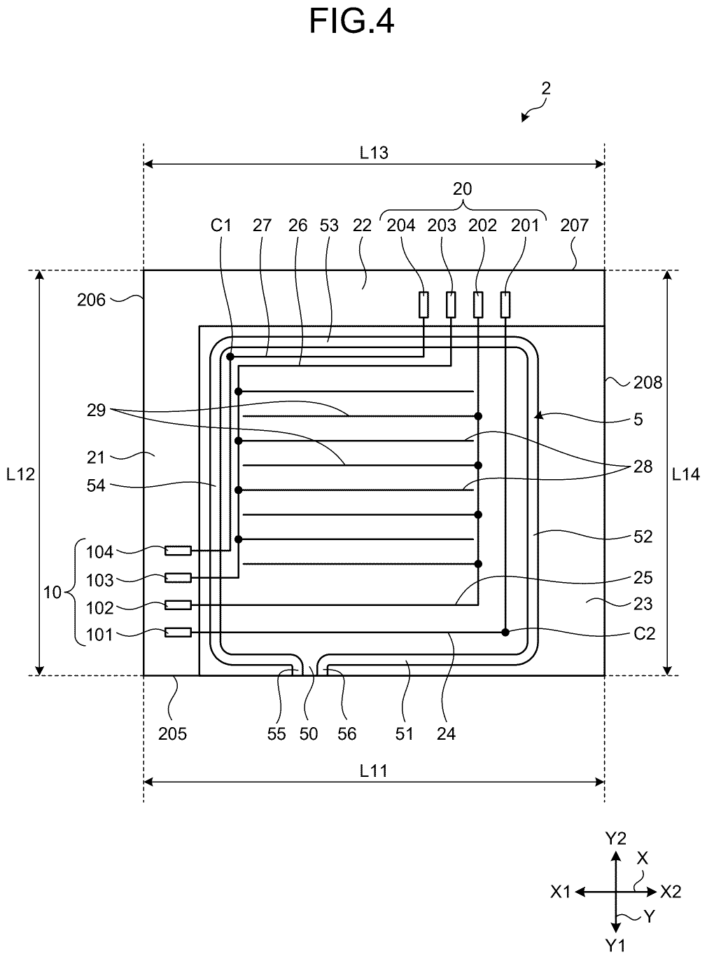

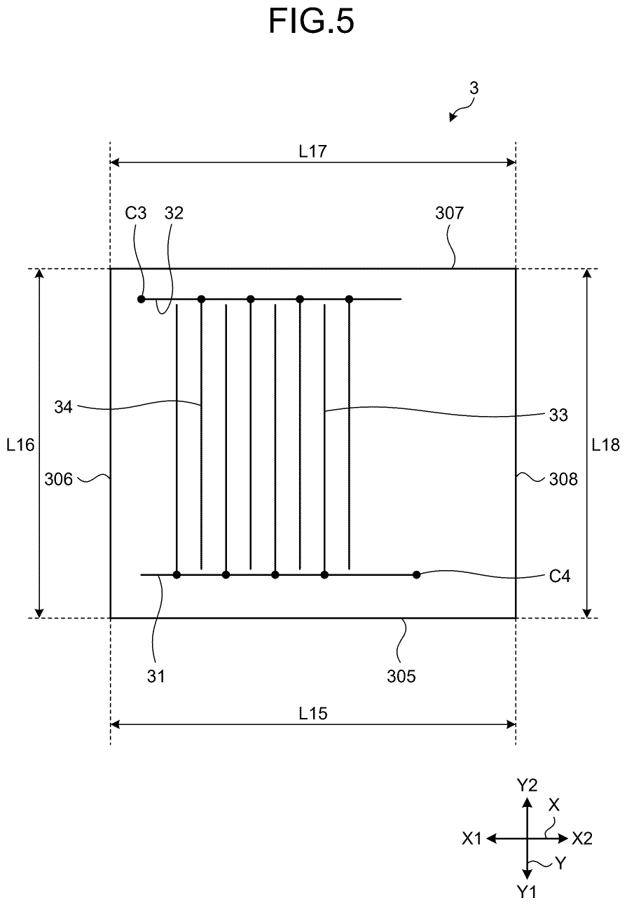

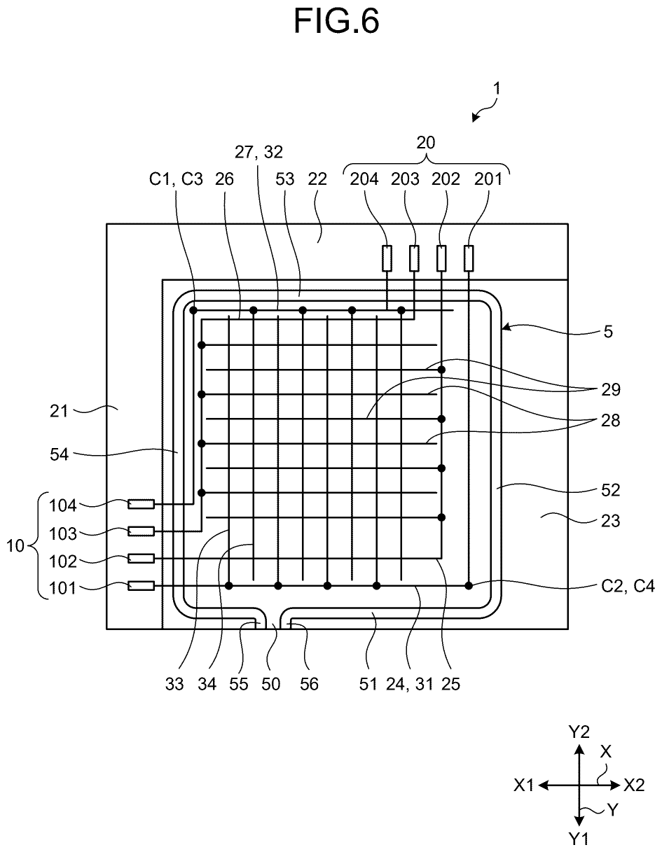

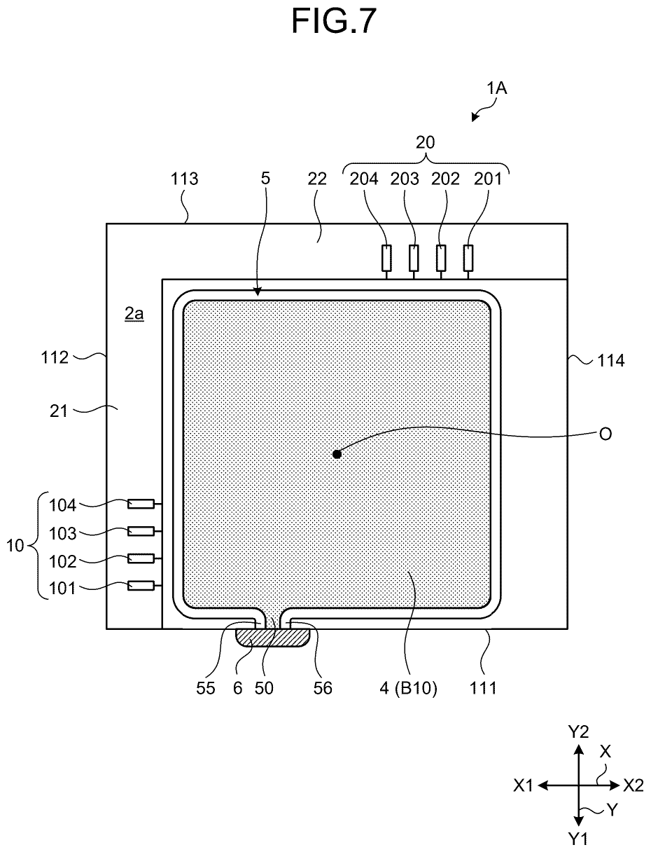

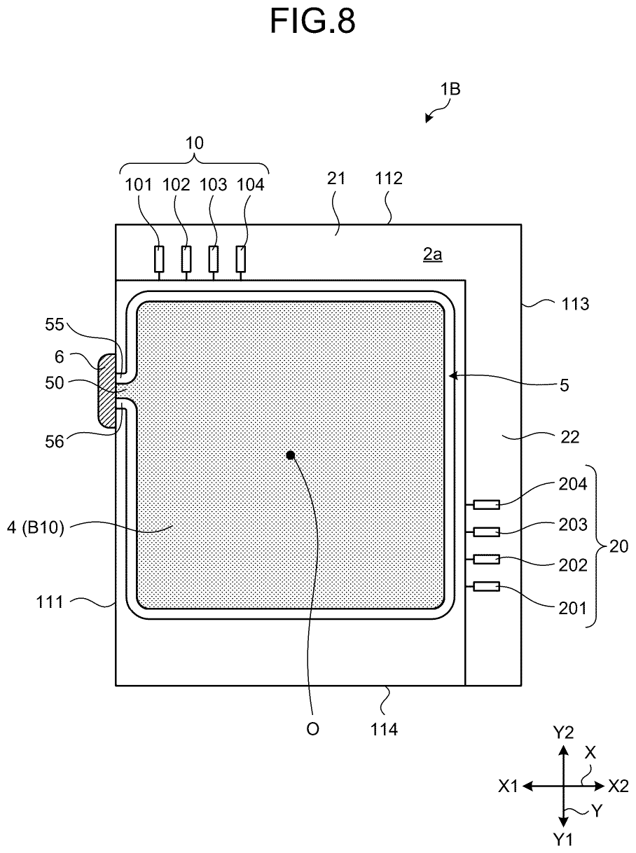

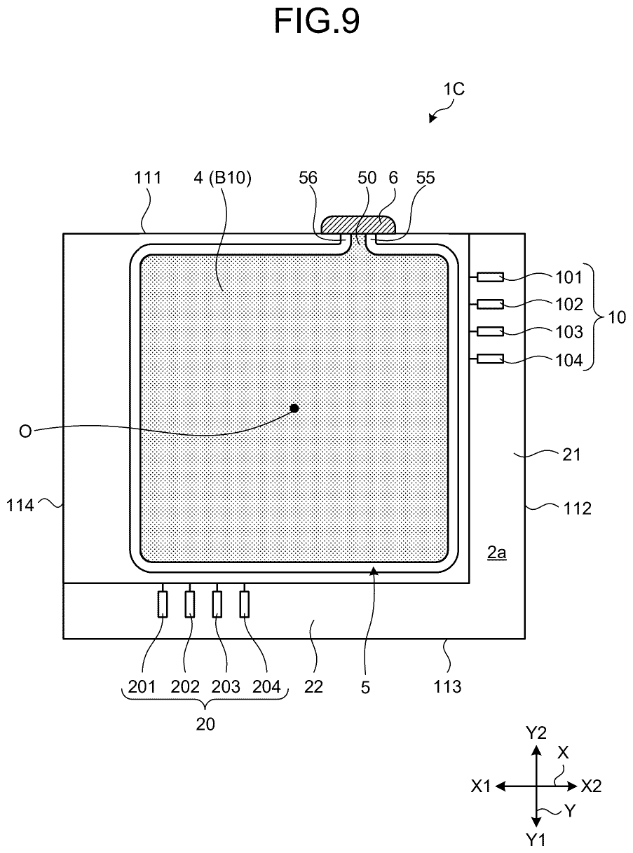

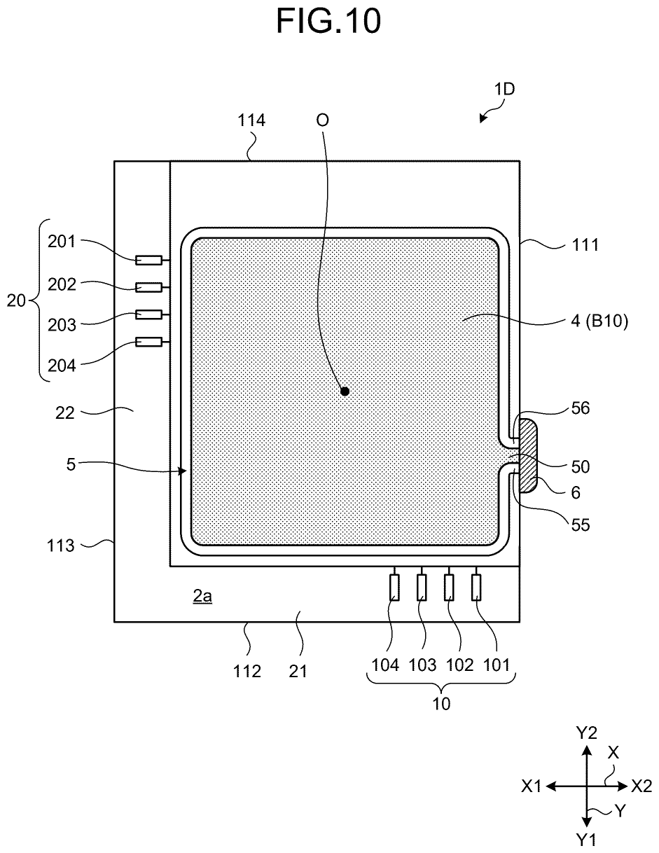

The following describes a light adjustment device according to a first embodiment. FIG. 1 is a schematic diagram of the light adjustment device according to the first embodiment when viewed from the upper side. FIG. 2 is a schematic diagram illustrating a section of the light adjustment device according to the first embodiment. FIG. 3 is a schematic diagram of a light adjustment panel according to the first embodiment when viewed from the upper side. FIG. 4 is a schematic diagram of a first substrate included in the light adjustment panel of FIG. 3 when viewed from the upper side. FIG. 5 is a schematic diagram of a second substrate included in the light adjustment panel of FIG. 3 when viewed from the upper side. FIG. 6 is a schematic diagram illustrating a state in which the first substrate of FIG. 4 and the second substrate of FIG. 5 are placed over each other. FIG. 7 is a schematic diagram illustrating the light adjustment panel positioned uppermost in a panel unit. FIG. 8 is a schematic diagram illustrating the light adjustment panel positioned second uppermost in the panel unit. FIG. 9 is a schematic diagram illustrating the light adjustment panel positioned third uppermost in the panel unit. FIG. 10 is a schematic diagram illustrating the light adjustment panel positioned fourth uppermost in the panel unit.

As illustrated in FIGS. 1 and 2, a light adjustment device 100 according to the first embodiment includes a panel unit 110 and a light source 120. In the light adjustment device according to the embodiment, a light adjustment panel (liquid crystal cell) for p-wave polarization and a light adjustment panel (liquid crystal cell) for s-wave polarization are stacked and combined. Specifically, a plurality of light adjustment panels for p-wave polarization and a plurality of light adjustment panels for s-wave polarization each obtained by rotating a light adjustment panel for p-wave polarization by 90° are stacked. As illustrated in FIG. 1, when the panel unit 110 is viewed in the Z direction, a central line extending in the Y direction through the center in the X direction is referred to as a central line CL1, a central line extending in the X direction through the center in the Y direction is referred to as a central line CL2, and a point where the central lines CL1 and CL2 intersect each other is referred to as a center O.

In the present embodiment, the edge of the panel unit 110 is square when viewed in the Z direction. In the present invention, the shape of the panel unit 110 is not limited to square, but various shapes such as hexagonal, octagonal, and other polygonal shapes as well as circular shapes are applicable.

The panel unit 110 is formed by stacking a plurality of light adjustment panels 1 in the Z direction (first direction). In the present embodiment, a plurality (in the embodiment, four) of light adjustment panels 1 are stacked. Specifically, as illustrated in FIG. 2, the four light adjustment panels 1 are a light adjustment panel 1A, a light adjustment panel 1B, a light adjustment panel 1C, and a light adjustment panel 1D stacked in order from the upper side. The light adjustment panel 1A is disposed furthest to the upper side among the four light adjustment panels 1. In other words, the light adjustment panel 1A is positioned furthest to the Z2 side among the light adjustment panels. The light adjustment panel 1D is disposed furthest to the lower side among the four light adjustment panels 1. In other words, the light adjustment panel 1D is positioned furthest to the Z1 side among the light adjustment panels. The light adjustment panels 1B and 1C are stacked between the light adjustment panels 1A and 1D. The light adjustment panels 1A, 1B, 1C, and 1D each include a first substrate 2 and a second substrate 3. A front surface 2a of the first substrate 2 and a front surface 3a of the second substrate 3 face each other with a liquid crystal layer 4 interposed therebetween. A back surface 2b of the first substrate 2 is a surface opposite the front surface 2a. A back surface 3b of the second substrate 3 is a surface opposite the front surface 3a. The light adjustment panels 1A, 1B, 1C, and 1D are bonded to each other through a light-transmitting bonding agent 140. In other words, all light adjustment panels adjacent to each other in the Z direction are bonded to each other through the light-transmitting bonding agent 140. The number of light adjustment panels 1 included in the light adjustment device 100 is not limited to four but may be two or more. The light source 120 is disposed on the Z2 side of the panel unit 110. Light 130 is emitted from the light source 120.

Each light adjustment panel 1 includes the first substrate 2, the second substrate 3, the liquid crystal layer 4, a first seal material 5, and a second seal material 6. As illustrated in FIG. 3, the light adjustment panel 1 is a rectangle that is long in the X direction when viewed in the Z direction. Specifically, the edge of the light adjustment panel 1 includes an edge 111, an edge 112, an edge 113, and an edge 114, and a rectangle that is long in the X direction is formed by the edges 111, 112, 113, and 114. A square is formed by a dashed and double-dotted line 119 on the Y1 side and the edges 112, 113, and 114.

The edge 111 is positioned on the Y2 side of the dashed and double-dotted line 119.

As illustrated in FIGS. 2 and 3, the liquid crystal layer 4 is provided on the light adjustment panel 1. A region where the liquid crystal layer 4 is provided is a light-transmitting region (effective region) B10. A region outside the light-transmitting region (effective region) B10 is a light-shielding region (frame region) A10. As illustrated in FIG. 2, the light 130 from the light source 120 proceeds to the Z1 side through the light-transmitting region B10 from the light adjustment panel 1D to the light adjustment panel 1A. As illustrated in FIG. 3, the liquid crystal layer 4 is substantially square when viewed in the Z direction. Specifically, the liquid crystal layer 4 has sides 41, 42, 43, and 44.

As illustrated in FIG. 3, the first seal material 5 is provided along the edge (sides 41, 42, 43, and 44) of the liquid crystal layer 4. The first seal material 5 has sides 51, 52, 53, and 54 and has a square shape when viewed in the Z direction. An injection opening 50 is provided on the side 51. Specifically, bending parts 55 and 56 are provided on the side 51, and a space between the bending parts 55 and 56 serves as the injection opening 50. Liquid crystal is injected toward the inside of the first seal material 5 through the injection opening 50. The distal ends of the bending parts 55 and 56 on the Y1 side are joined to the second seal material 6. The second seal material 6 is formed by, for example, applying and curing UV curable resin through drying. The second seal material 6 seals the injection opening 50 to prevent outflow of the liquid crystal. The second seal material 6 protrudes on the Y1 side (outside) of the edge 111.

As illustrated in FIG. 3, the Y-directional distance between the side 41 of the liquid crystal layer 4 and the edge 111 is distance L1. The X-directional distance between the side 42 of the liquid crystal layer 4 and the edge 112 is distance L2. The Y-directional distance between the side 43 of the liquid crystal layer 4 and the edge 113 is distance L3. The X-directional distance between the side 44 of the liquid crystal layer 4 and the edge 114 is distance L4. The Y-directional distance between the side 41 of the liquid crystal layer 4 and the distal end of the second seal material 6 is distance L5. The Y-directional distance between the side 41 of the liquid crystal layer 4 and the dashed and double-dotted line 119 is distance L6. The distances L2, L3, L4, and L6 are equal. The distance L1 is shorter than the distances L2, L3, L4, and L6. The distance L5 is shorter than the distances L2, L3, L4, and L6. The distance L5 is longer than the distance L1.

As illustrated in FIGS. 4 and 6, the first substrate 2 of each light adjustment panel 1 is provided with end parts 21, 22, and 23. The end part 21 is positioned on the X1 side of the liquid crystal layer 4, the end part 22 is positioned on the Y2 side of the liquid crystal layer 4, and the end part 21 is positioned on the X2 side of the liquid crystal layer 4. The first substrate 2 has four sides 205, 206, 207, and 208. The length of the side 205 is distance L11. The length of the side 206 is distance L12. The length of the side 207 is distance L13. The length of the side 208 is distance L14. The distances L11 and L13 are equal. The distances L12 and L14 are equal. The distances L11 and L13 are longer than the distances L12 and L14.

As illustrated in FIG. 4, a first terminal group 10 is provided at the end part 21. A second terminal group 20 is provided at the end part 22. The first terminal group 10 includes a first terminal 101, a second terminal 102, a third terminal 103, and a fourth terminal 104. The first terminal 101, the second terminal 102, the third terminal 103, and the fourth terminal 104 are disposed in the Y direction. The second terminal group 20 includes a fifth terminal 201, a sixth terminal 202, a seventh terminal 203, and an eighth terminal 204. The fifth terminal 201, the sixth terminal 202, the seventh terminal 203, and the eighth terminal 204 are disposed in the X direction.

As illustrated in FIG. 4, the first terminal 101 and the fifth terminal 201 are coupled to each other through a wire 24. A coupler C2 is provided on the wire 24. The second terminal 102 and the sixth terminal 202 are coupled to each other through a wire 25. The third terminal 103 and the seventh terminal 203 are coupled to each other through a wire 26. The fourth terminal 104 and the eighth terminal 204 are coupled to each other through a wire 27. A coupler C1 is provided on the wire 27. Liquid crystal drive electrodes 28 are coupled to the wire 26. Liquid crystal drive electrodes 29 are coupled to the wire 26. The liquid crystal drive electrodes 28 and 29 both extend in the X direction. The liquid crystal drive electrodes 28 and 29 are alternately arranged in the Y direction.

As illustrated in FIGS. 5 and 6, the second substrate 3 has sides 305, 306, 307, and 308. The length of the side 305 is distance L15. The length of the side 306 is distance L16. The length of the side 307 is distance L17. The length of the side 308 is distance L18. The distances L15 and L17 are equal. The distances L16 and L18 are equal. The distances L15 and L17 are longer than the distances L16 and L18. A wire 31 and a wire 32 extend in the X direction. A coupler C4 is provided on the wire 31. A coupler C3 is provided on the wire 32. The coupler C4 is coupled to the coupler C2 through a non-illustrated conductive pole. The coupler C3 is coupled to the coupler C1 through a non-illustrated conductive pole. Liquid crystal drive electrodes 33 are coupled to the wire 31. Liquid crystal drive electrodes 34 are coupled to the wire 32. The liquid crystal drive electrodes 33 and 34 both extend in the Y direction. The liquid crystal drive electrodes 33 and 34 are alternately arranged in the X direction.

The following describes the orientations of the light adjustment panels 1A, 1B, 1C, and 1D included in the panel unit 110 with reference to FIGS. 7 to 10. The light adjustment panel 1B is in a state of being rotated by 90° in the clockwise direction relative to the light adjustment panel 1A. Specifically, disposition of the light adjustment panel 1B illustrated in FIG. 8 is obtained by rotating the light adjustment panel 1A by 90° in the clockwise direction about the center O of the square liquid crystal layer 4 illustrated in FIG. 7. Disposition of the light adjustment panel 1C illustrated in FIG. 9 is obtained by rotating the light adjustment panel 1B by 90° in the clockwise direction about the center O. Disposition of the light adjustment panel 1D illustrated in FIG. 10 is obtained by rotating the light adjustment panel 1C by 90° in the clockwise direction about the center O.

As described above, the light adjustment device 100 of the first embodiment includes the panel unit 110 in which a plurality of light adjustment panels 1 are stacked in the Z direction (first direction). Each of the light adjustment panels 1 includes the first substrate 2, the second substrate 3 overlapping the first substrate 2, the liquid crystal layer 4 positioned between the first substrate 2 and the second substrate 3, the first seal material 5 extending along the edge of the liquid crystal layer 4 between the first substrate 2 and the second substrate 3 and provided with the injection opening 50, and the second seal material 6 sealing the injection opening 50, the second seal material 6 protruding outward from the edge 111 of the light adjustment panel 1 when viewed in the Z direction. When each of the light adjustment panels 1 is sequentially designated as one light adjustment panel 1, the second seal material 6 of the one light adjustment panel 1 is positioned inside the edges of the other light adjustment panels 1 other than the one light adjustment panel 1 when viewed in the Z direction.

As described above, when the second seal material of the injection opening protrudes from a side part of the panel unit in which the light adjustment panels are vertically stacked, the second seal material is potentially damaged during conveyance of the panel unit, for example.

However, in the present embodiment, when each of the light adjustment panels 1 is sequentially designated as one light adjustment panel 1, the second seal material 6 of the one light adjustment panel 1 is positioned inside the edges of the other light adjustment panels 1 other than the one light adjustment panel 1 when viewed in the Z direction. Specifically, the second seal material 6 of the light adjustment panel 1A is positioned inside the edges of the light adjustment panels 1B, 1C, and 1D. The second seal material 6 of the light adjustment panel 1B is positioned inside the edges of the light adjustment panels 1A, 1C, and 1D. The second seal material 6 of the light adjustment panel 1C is positioned inside the edges of the light adjustment panels 1A, 1B, and 1D. The second seal material 6 of the light adjustment panel 1D is positioned inside the edges of the light adjustment panels 1A, 1B, and 1C. Accordingly, the second seal material 6 does not protrude from the side part of the panel unit 110, and thus is prevented from being damaged during conveyance of the panel unit 110, for example.

The edge of the panel unit 110 and the edge of each light adjustment panel 1 is rectangular (polygonal) when viewed in the Z direction (first direction). Since the light adjustment panels 1A, 1B, 1C, and 1D are rectangular, only the sides of the light adjustment panels 1 need to be aligned with each other in the Z direction when the light adjustment panels 1 are rotated by 90° relative to each other and sequentially stacked, which facilitates stacking work.

### Second Embodiment

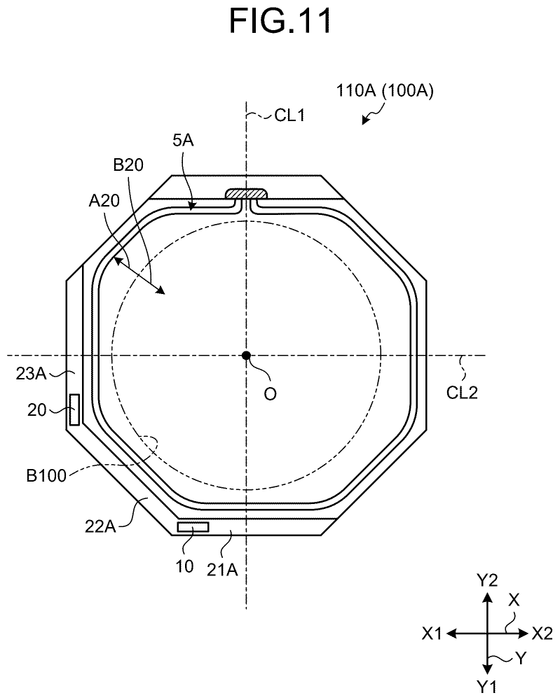

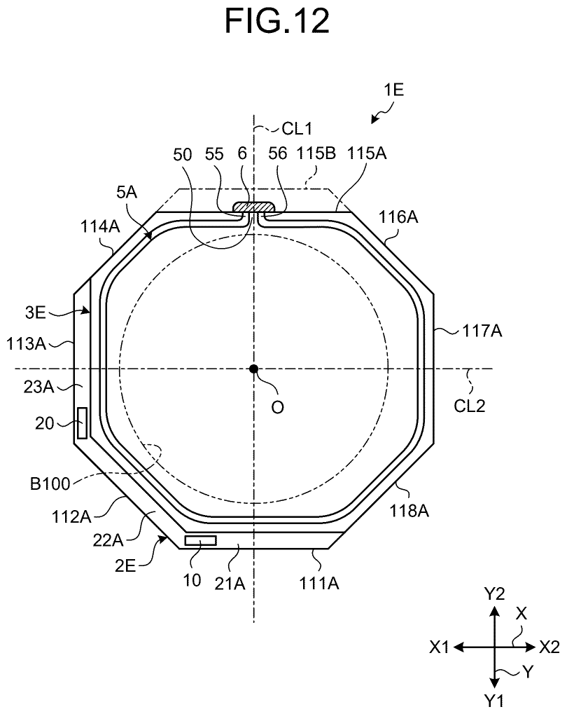

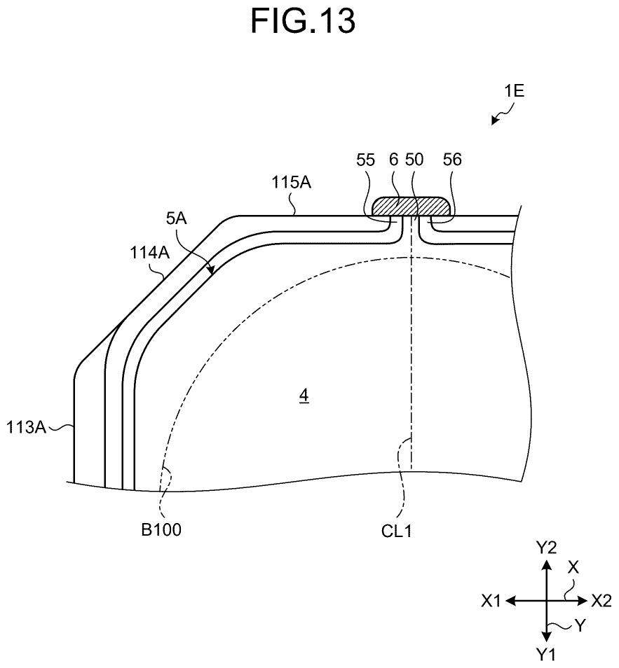

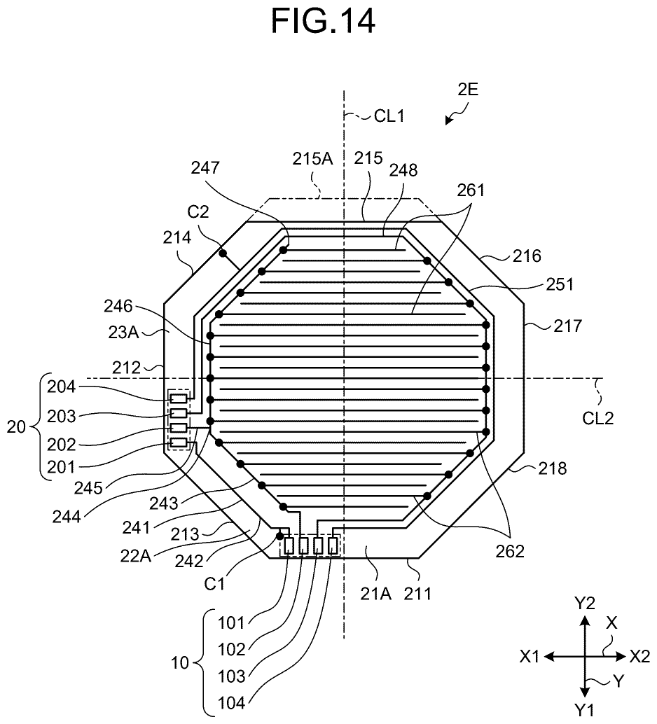

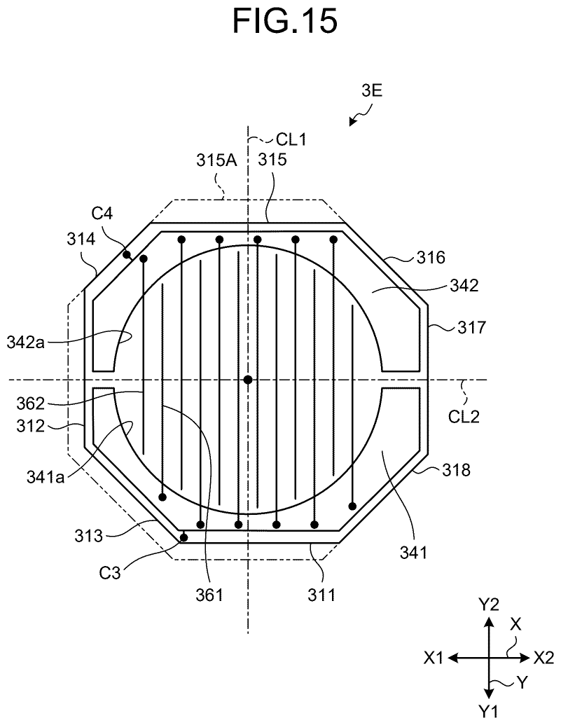

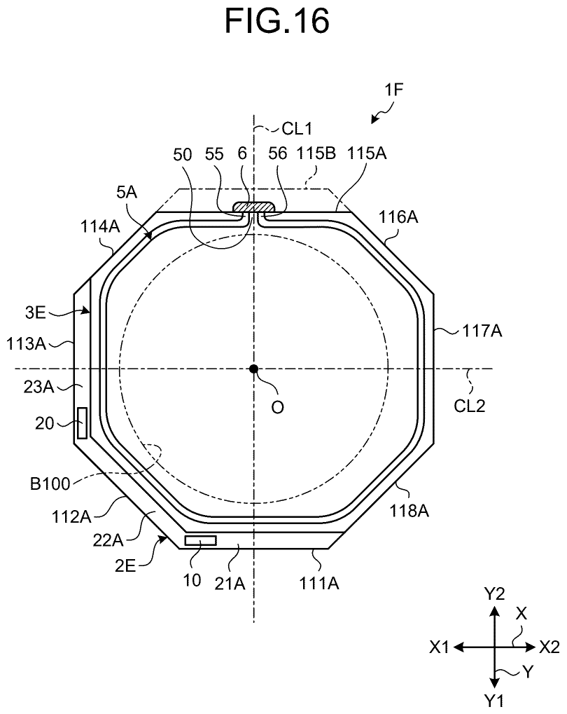

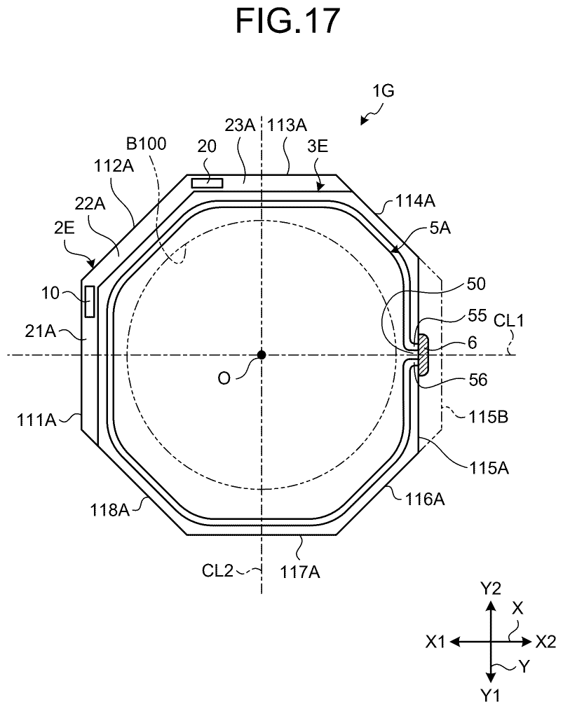

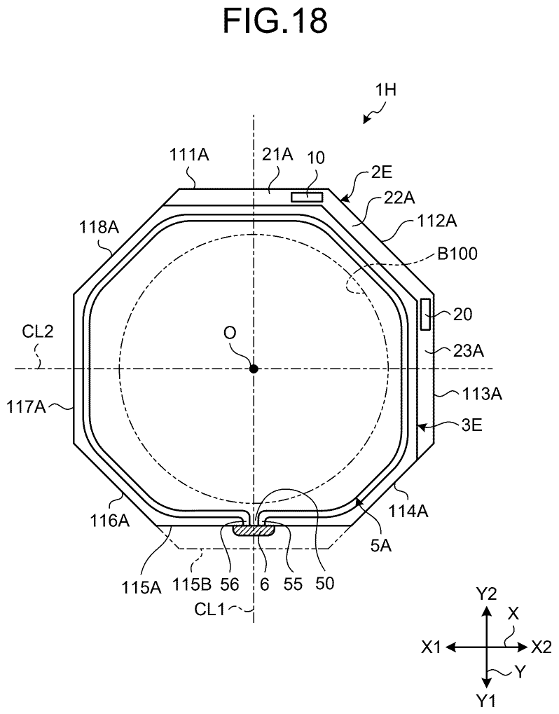

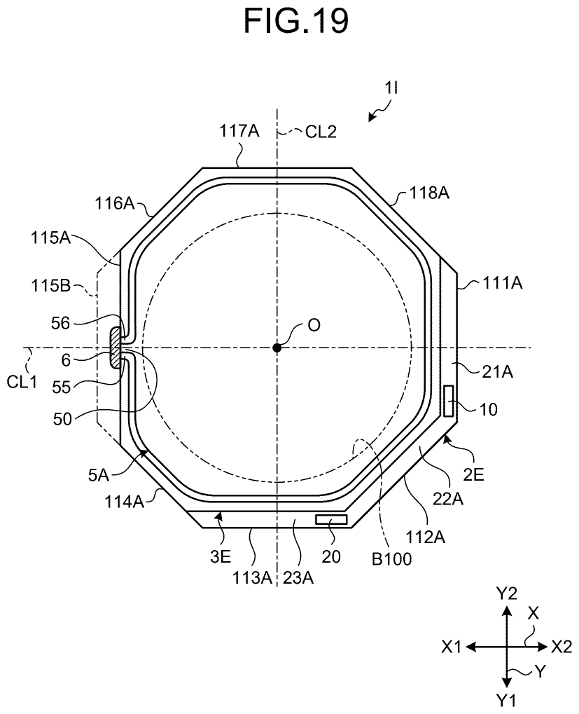

The following describes a light adjustment device according to a second embodiment. FIG. 11 is a schematic diagram of the light adjustment device according to the second embodiment when viewed from the upper side. FIG. 12 is a schematic diagram of light adjustment panel according to the second embodiment when viewed from the upper side. FIG. 13 is a schematic diagram illustrating part of FIG. 12 in an enlarged manner. FIG. 14 is a schematic diagram of a first substrate included in the light adjustment panel of FIG. 12 when viewed from the upper side. FIG. 15 is a schematic diagram of a second substrate included in the light adjustment panel of FIG. 12 when viewed from the upper side. FIG. 16 is a schematic diagram illustrating the light adjustment panel positioned uppermost in the panel unit. FIG. 17 is a schematic diagram illustrating the light adjustment panel positioned second uppermost in the panel unit. FIG. 18 is a schematic diagram illustrating the light adjustment panel positioned third uppermost in the panel unit. FIG. 19 is a schematic diagram illustrating the light adjustment panel positioned fourth uppermost in the panel unit.

Although the first embodiment describes the aspect in which the shapes of the panel unit and each light adjustment panel are rectangular, the second embodiment describes an aspect in which the shapes of the panel unit and each light adjustment panel are octagonal.

A light adjustment device 100A according to the second embodiment includes a panel unit 110A. As illustrated in FIG. 11, the panel unit 110A is regular octagonal when viewed in the Z direction. The panel unit 110A is formed by stacking four light adjustment panels 1E in the Z direction (first direction). Specifically, the four light adjustment panels 1E are a light adjustment panel 1F, a light adjustment panel 1G, a light adjustment panel 1H, and a light adjustment panel 1I in order from the upper side.

As illustrated in FIGS. 11 and 12, each light adjustment panel 1E is octagonal when viewed in the Z direction. Specifically, the edge of the light adjustment panel 1E includes an edge 111A, an edge 112A, an edge 113A, an edge 114A, an edge 115A, an edge 116A, an edge 117A, and an edge 118A. A regular octagon is formed by a dashed and double-dotted line 115B on the Y2 side and the edges 111A, 112A, 113A, 114A, 116A, 117A, and 118A. The edge 115A is positioned on the Y1 side of the dashed and double-dotted line 115B. As illustrated in FIGS. 12 and 13, the second seal material 6 protrudes on the Y2 side (outside) of the edge 115A.

A circle B100 illustrated with a dashed and double-dotted line is the boundary between a light-shielding region (frame region) A20 and a light-transmitting region (effective region) B20. The inside of the circle B100 is the light-transmitting region B20, and the outside of the circle B100 is the light-shielding region A20. The circle B100 has a center O. As illustrated in FIG. 11, a central line CL1 extending in the Y direction through the center of the panel unit 110A in the X direction and a central line CL2 extending in the X direction through the center of the panel unit 110A in the Y direction intersect each other at the center O. The circle B100 coincides with inner edges 341a and 342a of planar electrodes 341 and 342 to be described later. The light adjustment panel 1E is provided with end parts 21A, 22A, and 23A. The first terminal group 10 is provided at the end part 21A, and the second terminal group 20 is provided at the end part 23A. A first seal material 5A is provided outside the circle B100.

As illustrated in FIG. 14, a first substrate 2E has sides 211, 212, 213, 214, 215, 216, 217, and 218. A dashed and double-dotted line 215A corresponds to a side of the regular octagon. The side 215 is positioned on the Y1 side (inside) of the dashed and double-dotted line 215A.

Wires, liquid crystal drive electrodes, and couplers are provided on the front surface 2a of the first substrate 2. The coupler C1 of the first substrate 2 and the coupler C3 (refer to FIG. 15) of the second substrate 3 are electrically coupled to each other through a conductive pole (not illustrated) through which conduction is possible. Similarly, the coupler C2 of the first substrate 2 and the coupler C4 (refer to FIG. 3) of the second substrate 3 are electrically coupled to each other through a conductive pole (not illustrated) through which conduction is possible.

The first terminal 101 and the fifth terminal 201 are electrically coupled to each other through a wire 241. A bifurcation point 242 is provided halfway through the wire 241, and a wire extends from the bifurcation point 242 to the coupler C1.

The second terminal 102 and the sixth terminal 202 are electrically coupled to each other through wires 243 and 245. A bifurcation point 244 is provided on the wire 243, and a wire 246 extends from the bifurcation point 244 to an end 247.

The third terminal 103 and the seventh terminal 203 are electrically coupled to each other through a wire 248. The fourth terminal 104 and the eighth terminal 204 are electrically coupled to each other through a wire 251. The wire 251 is coupled to the coupler C2.

A plurality of liquid crystal drive electrodes 261 are coupled to the wires 243 and 246. The liquid crystal drive electrodes 261 extend straight in the X direction. The liquid crystal drive electrodes 261 are disposed at equal intervals in the Y direction.

A plurality of liquid crystal drive electrodes 262 are coupled to the wire 248. The liquid crystal drive electrodes 262 extend straight in the X direction. The liquid crystal drive electrodes 262 are disposed at equal intervals in the Y direction. The liquid crystal drive electrodes 261 and 262 are alternately arranged in the Y direction.

As illustrated in FIG. 15, a second substrate 3E has sides 311, 312, 313, 314, 315, 316, 317, and 318. The side 315 is positioned on the Y1 side (inside) of a dashed and double-dotted line 315A. The two planar electrodes 341 and 342 are provided on the second substrate 3. The planar electrodes 341 and 342 are, for example, black metal patterns and have an effect of shielding light 130. The planar electrode 341 is positioned on the Y1 side, and the planar electrode 342 is positioned on the Y2 side. The outer edges of the planar electrodes 341 and 342 are substantially octagonal. The inner edge 341a of the planar electrode 341 and the inner edge 342a of the planar electrode 342 extend along the circle B100 (refer to FIG. 12) about the center O. Accordingly, the inside of the inner edges 341a and 342a is the light-transmitting region (effective region) B20, and the outside of the inner edges 341a and 342a is the light-shielding region (frame region) A20. The coupler C3 is coupled to the planar electrode 341, and the coupler C4 is coupled to the planar electrode 342. Liquid crystal drive electrodes 361 and 362 extend in the Y direction. The liquid crystal drive electrodes 361 are coupled to the planar electrode 341. The liquid crystal drive electrodes 362 are coupled to the planar electrode 342.

The following describes the orientations of the light adjustment panels 1F, 1G, 1H, and 1I included in the panel unit 110A with reference to FIGS. 16 to 19. The light adjustment panel 1G is in a state of being rotated by 90° in the clockwise direction relative to the light adjustment panel 1F. Specifically, disposition of the light adjustment panel 1G illustrated in FIG. 17 is obtained by rotating the light adjustment panel 1F illustrated in FIG. 16 by 90° in the clockwise direction about the center O. Disposition of the light adjustment panel 1H illustrated in FIG. 18 is obtained by rotating the light adjustment panel 1G by 90° in the clockwise direction about the center O. Disposition of the light adjustment panel 1I illustrated in FIG. 19 is obtained by rotating the light adjustment panel 1H by 90° in the clockwise direction about the center O.

As described above, the edge of the panel unit 110A and the edge of each light adjustment panel 1E according to the second embodiment are octagonal (polygonal) when viewed in the Z direction (first direction). In this case as well, since the light adjustment panels 1F, 1G, 1H, and 1I are octagonal, only the sides of the light adjustment panels 1 need to be aligned with each other in the Z direction when the light adjustment panels 1 are rotated by 90° relative to each other and sequentially stacked, which facilitates stacking work.

Moreover, the octagonal-pillar panel unit 110A according to the second embodiment is more compact than the rectangular-pillar panel unit 110 according to the first embodiment.

### Third Embodiment

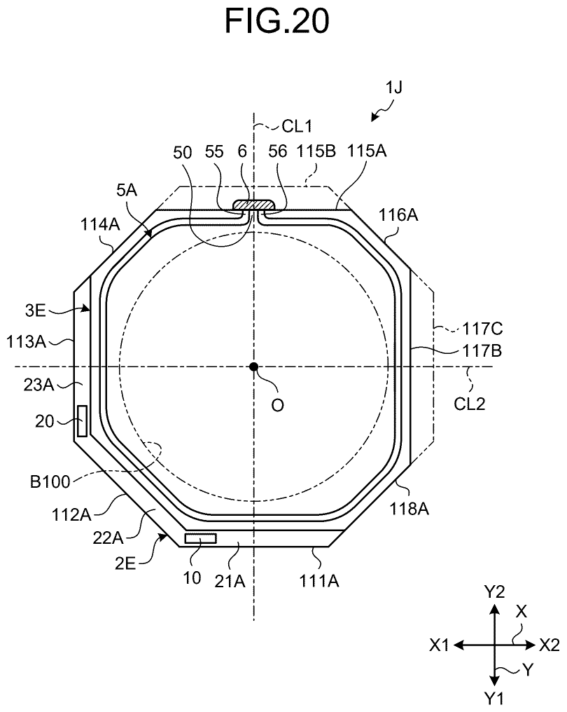

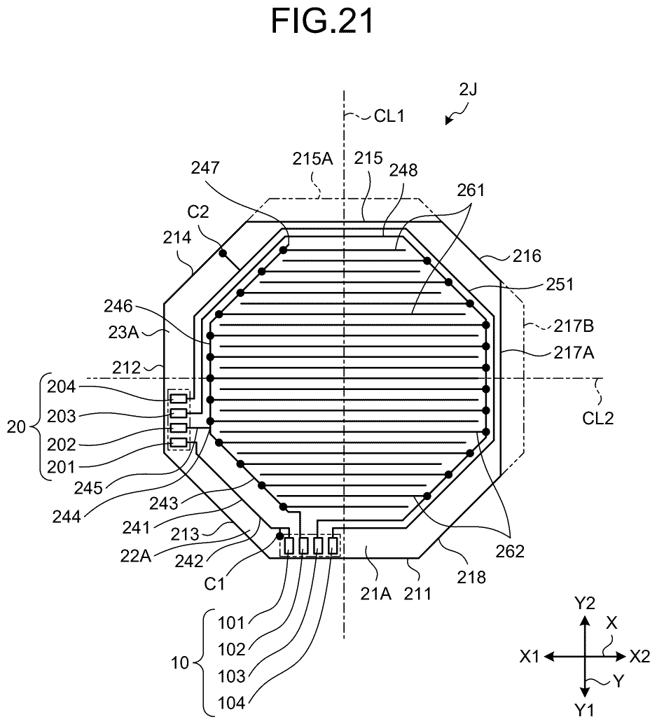

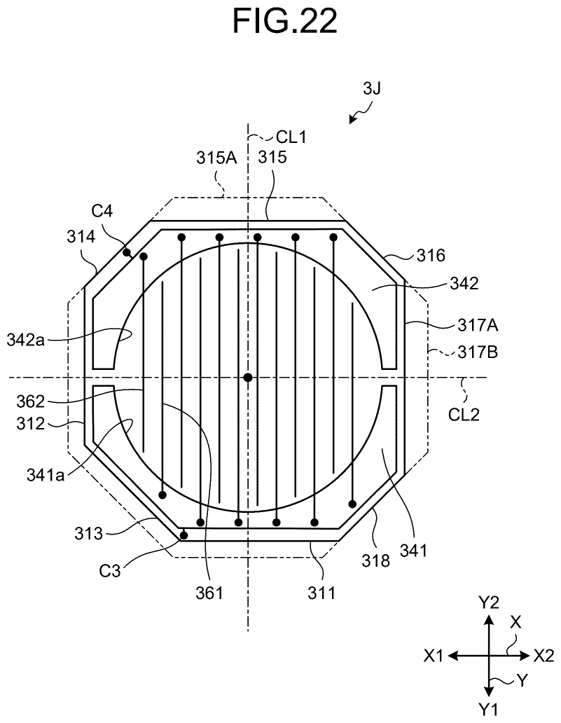

The following describes a light adjustment device according to a third embodiment. FIG. 20 is a schematic diagram of the light adjustment panel according to the third embodiment when viewed from the upper side. FIG. 21 is a schematic diagram of a first substrate included in the light adjustment panel of FIG. 20 when viewed from the upper side. FIG. 22 is a schematic diagram of a second substrate included in the light adjustment panel of FIG. 20 when viewed from the upper side.

Light adjustment panels 1J according to the third embodiment differ from the light adjustment panels 1E according to the second embodiment by an edge 117B. The following description focuses on the edge 117B.

A dashed and double-dotted line 117C illustrated in FIG. 20 is a virtual side of a regular octagon. The edge 117B of each light adjustment panel 1J is positioned on the X1 side of the dashed and double-dotted line 117C. Accordingly, the first seal material 5A has a shape along the edge 117B.

As illustrated in FIG. 21, a side 217A of a first substrate 2J is positioned on the X1 side of a dashed and double-dotted line 217B that is a virtual side of the regular octagon. As illustrated in FIG. 22, a side 317A of a second substrate 3J is positioned on the X1 side of a dashed and double-dotted line 317B that is a virtual side of the regular octagon. All other shapes and wires are the same as in the second embodiment.

As described above, in the third embodiment, the edge of each light adjustment panel 1J is octagonal (polygonal) when viewed in the Z direction (first direction), and the edge 117B of the light adjustment panel 1J is disposed inside the edge 117A of each light adjustment panel 1E according to the second embodiment. Accordingly, the length of the light adjustment panel 1J in the right-left direction is shorter than that of the light adjustment panel 1E. Thus, in a case where a plurality of light adjustment panels are cut out from a parent material substrate extending long in the right-left direction, the parent material substrate of the light adjustment panel 1J can be arranged more than that of the light adjustment panel 1E for a parent material substrate with the same length. This allows more light adjustment panels 1J to be cut out from a parent material substrate of the same length.

### Fourth Embodiment

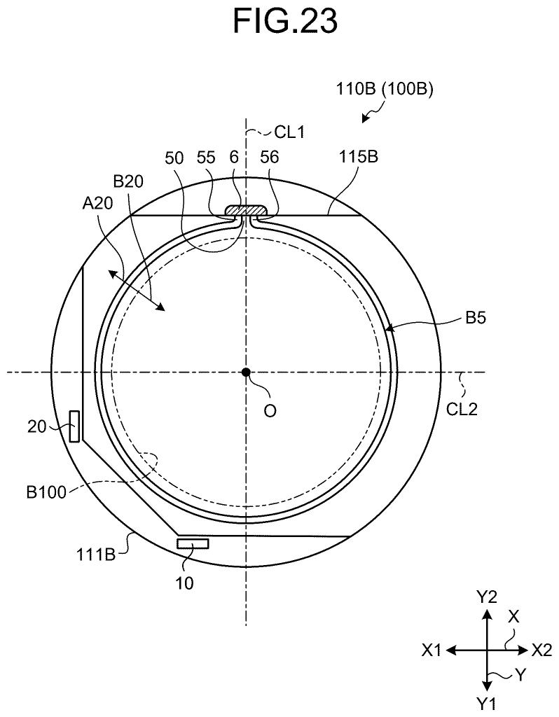

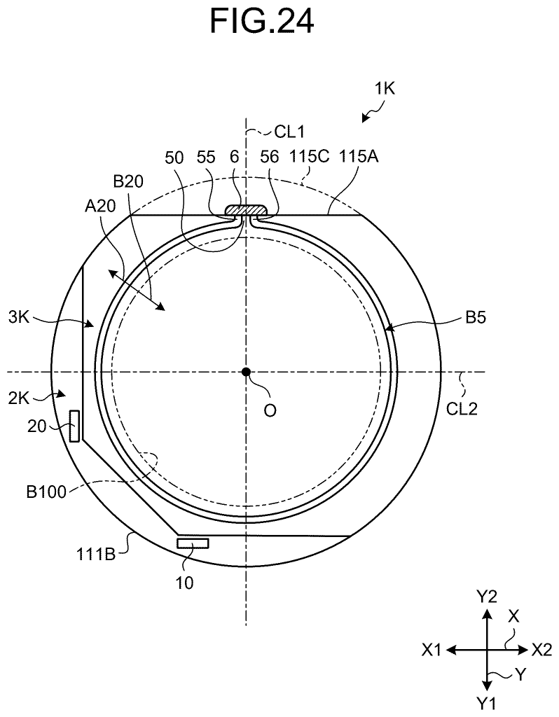

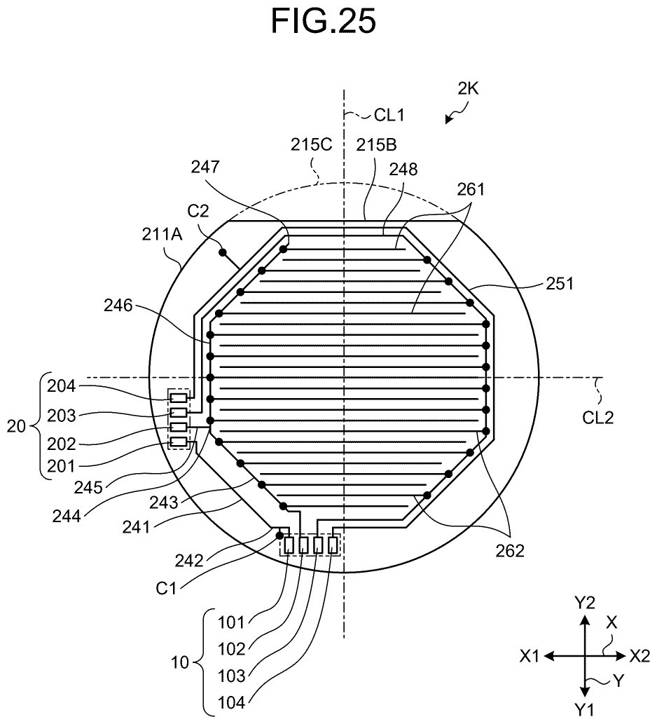

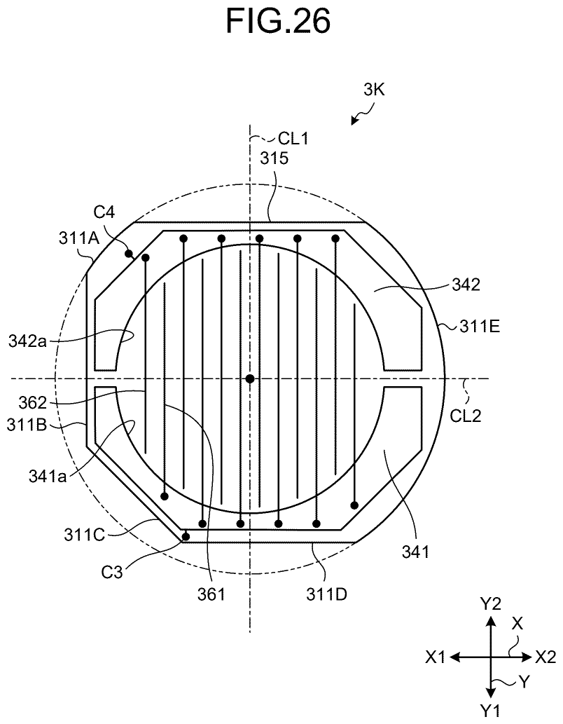

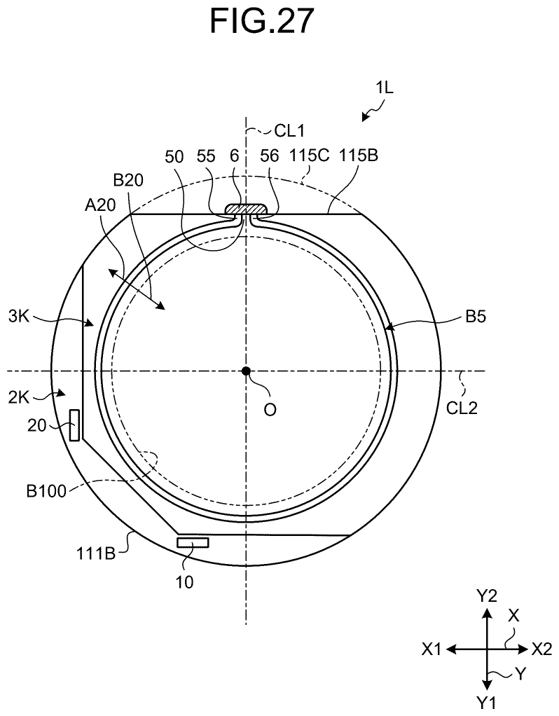

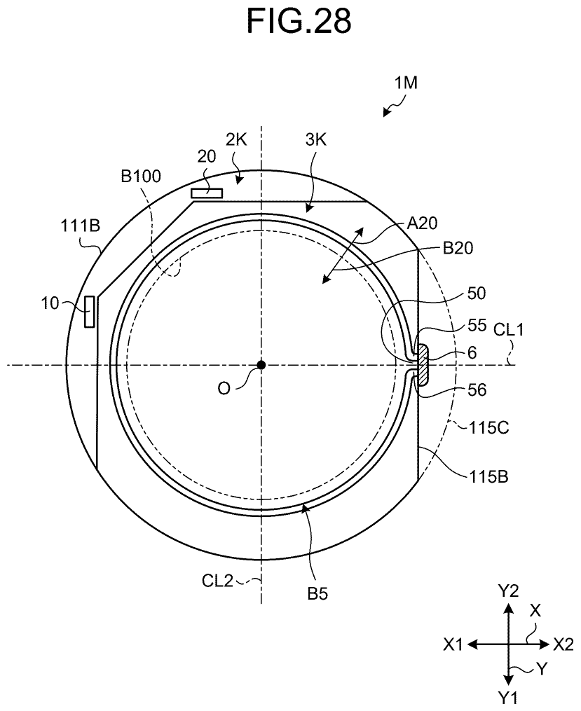

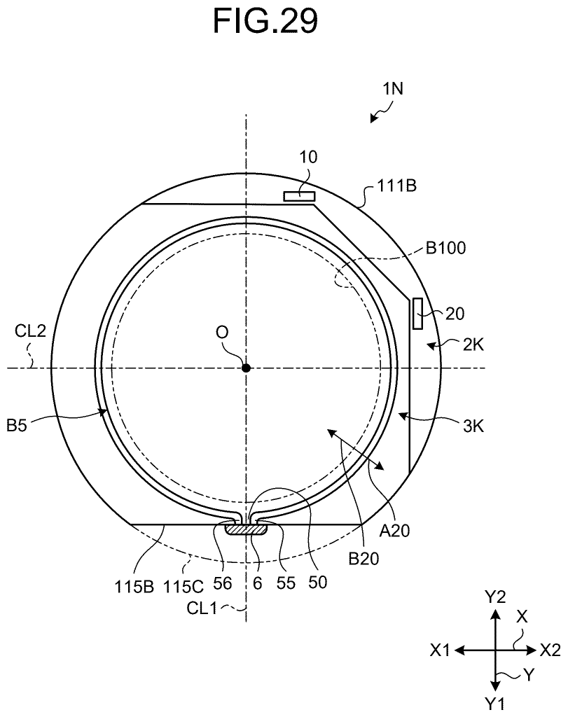

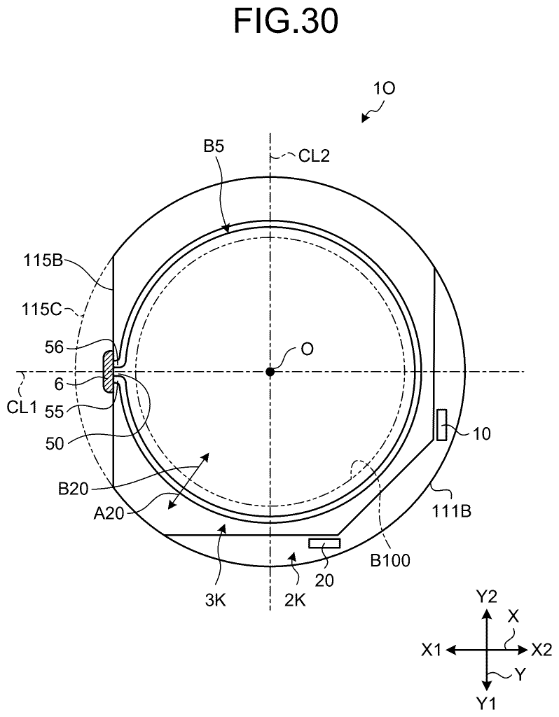

The following describes a light adjustment device according to a fourth embodiment. FIG. 23 is a schematic diagram of the light adjustment device according to the fourth embodiment when viewed from the upper side. FIG. 24 is a schematic diagram of light adjustment panel according to the fourth embodiment when viewed from the upper side. FIG. 25 is a schematic diagram of a first substrate included in the light adjustment panel of FIG. 24 when viewed from the upper side. FIG. 26 is a schematic diagram of a second substrate included in the light adjustment panel of FIG. 24 when viewed from the upper side. FIG. 27 is a schematic diagram illustrating the light adjustment panel positioned uppermost in the panel unit. FIG. 28 is a schematic diagram illustrating the light adjustment panel positioned second uppermost in the panel unit. FIG. 29 is a schematic diagram illustrating the light adjustment panel positioned third uppermost in the panel unit. FIG. 30 is a schematic diagram illustrating the light adjustment panel positioned fourth uppermost in the panel unit.

Although the second and third embodiments describe the aspect in which the shapes of the panel unit and each light adjustment panel are octagonal, the fourth embodiment describes an aspect in which the shapes of the panel unit and each light adjustment panel are circular.

A light adjustment device 100B according to the fourth embodiment includes a panel unit 110B. As illustrated in FIG. 23, the panel unit 110B is circular when viewed in the Z direction. The panel unit 110B is formed by stacking four light adjustment panels 1 in the Z direction (first direction). Specifically, the four light adjustment panels 1 are a light adjustment panel 1L, a light adjustment panel 1M, a light adjustment panel 1N, and a light adjustment panel 1O in order from the upper side.

As illustrated in FIGS. 23 and 24, each light adjustment panel 1K is circular when viewed in the Z direction. Specifically, the edge of the light adjustment panel 1K includes an edge 111B and an edge 115A. The edge 111B is circular about a center O. A first seal material 5B is circular about the center O. The edge 115A is straight when viewed in the Z direction. The second seal material 6 protrudes on the Y2 side of the edge 115A. A dashed and double-dotted line 115C is a partial arc of a circle along the edge 111B.

As illustrated in FIG. 25, a first substrate 2K is provided with the same wires and liquid crystal drive electrodes as those in the second embodiment but has a circular outer shape. Specifically, the edge of the first substrate 2K includes an edge 211A and an edge 215B. The edge 211A is circular and coincides with the edge 111B. The edge 215B is straight and coincides with the edge 115A. A dashed and double-dotted line 215C is a partial arc of the circle of the edge 211A.

As illustrated in FIG. 26, a second substrate 3K is provided with the same wires and liquid crystal drive electrodes as those in the second embodiment but has a circular outer shape. Specifically, the edge of the second substrate 3K includes a side 315, an edge 311A, an edge 311B, an edge 311C, an edge 311D, and an edge 311E. The side 315 is straight and coincides with the edge 115A. The edges 311A and 311E are partial arcs of a circle about the center O. The edges 311A and 311E coincide with the edge 111B.

The following describes the orientations of the light adjustment panels 1L, 1M, 1N, and 1O included in the panel unit 110B with reference to FIGS. 27 to 30. The light adjustment panel 1M is in a state of being rotated by 90° in the clockwise direction relative to the light adjustment panel 1L. Specifically, disposition of the light adjustment panel 1M illustrated in FIG. 28 is obtained by rotating the light adjustment panel 1L illustrated in FIG. 27 by 90° in the clockwise direction about the center O. Disposition of the light adjustment panel 1N illustrated in FIG. 29 is obtained by rotating the light adjustment panel 1M by 90° in the clockwise direction about the center O. Disposition of the light adjustment panel 1O illustrated in FIG. 30 is obtained by rotating the light adjustment panel 1N by 90° in the clockwise direction about the center O.

As described above, in the fourth embodiment, the edge of the panel unit 110B and the edge of each light adjustment panel 1K are circular when viewed in the Z direction (first direction). Since the side part of the panel unit 110B has fewer angulated parts than the polygonal panel unit 110 as in the first to third embodiments, the panel unit 110B is less damaged when the side part of the panel unit 110B is hit by an obstacle or other object.

What is claimed is:

1. A light adjustment device comprising a panel unit in which a plurality of light adjustment panels are stacked in a first direction, wherein
each of the light adjustment panels includes a first substrate, a second substrate overlapping the first substrate, a liquid crystal layer positioned between the first and second substrates, a first seal material extending along an edge of the liquid crystal layer between the first and second substrates and provided with an injection opening, and a second seal material sealing the injection opening, the second seal material protruding outward from the edge of the light adjustment panel when viewed in a first direction, and
when each of the light adjustment panels is sequentially designated as one light adjustment panel, the second seal material of the one light adjustment panel is positioned inside the edges of the other light adjustment panels other than the one light adjustment panel when viewed in the first direction.

2. The light adjustment device according to claim 1, wherein an edge of the panel unit and the edge of each of the light adjustment panels are polygonal when viewed in the first direction.

3. The light adjustment device according to claim 2, wherein the edge of the panel unit and the edge of each of the light adjustment panels are rectangular when viewed in the first direction.

4. The light adjustment device according to claim 2, wherein the edge of the panel unit and the edge of each of the light adjustment panels are octagonal when viewed in the first direction.

5. The light adjustment device according to claim 1, wherein the edge of the panel unit and the edge of each of the light adjustment panels are circular when viewed in the first direction.
